(19) United States
(12) Patent Application Publication
(10) Pub. No.: US 2018/0098136 A1
(43) Pub. Date: Apr. 5, 2018

(54) PUSH TELEMETRY DATA ACCUMULATION

(71) Applicant: Intel Corporation, Santa Clara, CA (US)

(72) Inventors: RAMAMURTHY KRITHIVAS, Chandler, AZ (US); DONGLAI DAI, Pleasanton, CA (US); RUSSELL WUNDERLICH, Livermore, CO (US); ESWARAMOORTHI NALLUSAMY, Puyallup, WA (US)

(73) Assignee: Intel Corporation, Santa Clara, CA (US)

(21) Appl. No.: 15/281,233

(22) Filed: Sep. 30, 2016

(51) Int. Cl. H04Q 9/00

(52) U.S. Cl. CPC H04Q 9/00; H04Q 2209/845; H04Q 2209/826

(57) ABSTRACT

The present disclosure is directed to push telemetry data accumulation. A system may comprise at least telemetry circuitry configured to push telemetry data (e.g., provide telemetry data without first receiving a request). An example system may comprise one or more devices that include at least one set of telemetry circuitry. The at least one set of telemetry circuitry may be configured to push data based at least on a frequency configuration and a skew configuration. The frequency configuration may control how often the at least one set of telemetry circuitry generates data. The skew configuration may control when the telemetry data is transmitted. For example, sets of telemetry circuitry may be configured with different skew configurations to minimize transmission overlap. This may prevent telemetry data accumulation (TDA) circuitry in the system, which receives the transmission of telemetry data from the at least one set of telemetry circuitry, from becoming overwhelmed.

### TECHNICAL FIELD

The present disclosure relates to electronic device operation, and more particularly, to a telemetry data push system that manages telemetry data flow using at least periodicity and skew.

### BACKGROUND

The operation of electronic systems may be managed based on information from which the current condition of the system may be determined. For example, power consumption, data traffic, temperature, up time (e.g., the time that the system is continuously operational) etc. may be monitored and reported for one or more devices in the system. This type of information may be generally termed “telemetry” data. In existing systems, intellectual property (IPs) such as, for example, integrated circuits (ICs), chipsets, multichip modules, etc. may provide telemetry data in a “request-response” mode of operation. In this type of operation, a request is sent to one or more IPs requesting telemetry data. The one or more IPs may provide the requested telemetry data, which may be utilized by control resources to manage operation of the electronic system.

For example, computing systems may utilize microprocessors (e.g., such as processors manufactured by the Intel Corporation) including additional functionality to support processor operation. The functionality may reside within the physical package of the processor to support operation of one or more processing cores (e.g., the “uncore”), or within separate ICs, chipsets, etc. For example, an uncore portion of a processor may include a power controller unit (PCU) to manage processor power consumption, while a platform controller hub (PCH) including at least one IC external to the processor may include a power management controller (PMC) to manage power consumption in the device (e.g., device awake/sleep states). The PCU and/or PMC may accumulate performance, power, thermal, etc. telemetry information from various IPs. Example telemetry data source IPs include various peripheral component interconnect express (PCIe) IPs mapped to a PCIe configuration (PCIe Config) space (e.g., at least one memory register to which data may be written), a memory-mapped input/output (MMIO) space, etc., a memory controller, a power supply unit, digital thermal sensors, integrated/discrete variable reluctance (VR) sensors, etc. Example in-band (IB) recipients for telemetry data may include host-based software (SW) agents that receive telemetry data via model-specific registers (MSRs), command status registers (CSRs), etc. Example out-of-band (OOB) recipients for telemetry data may include management engine (ME), innovation engine (IE) and/or baseboard management controller (BMC)-based firmware (FW) agents. The telemetry data may be conveyed to the various recipients via, for example, a processor environmental control interface (PECI) in-band, wired interface.

The implementation of OOB-meta state machines (MSM) enables multiple agents (e.g., based on host, IE, ME, and BMC) to collect telemetry information from IPs. However, requests may be queued and serviced as round-robin “request-response” only. Although two FW agents may initiate a request at the same-time-instant, responses may be delayed based on time it takes to complete a single request-response. This make correlation of different telemetry data difficult, may negatively impact system efficiency, responsiveness, etc., and thus overall system operation.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates examples of push telemetry data accumulation in accordance with at least one embodiment of the present disclosure;

FIG. 2 illustrates an example configuration for a device usable in accordance with at least one embodiment of the present disclosure;

FIG. 3 illustrates an example configuration for a telemetry system in accordance with at least one embodiment of the present disclosure; and

FIG. 4 illustrates example operations for push telemetry data accumulation in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The present disclosure is directed to push telemetry data accumulation. A system may comprise at least telemetry circuitry configured to push telemetry data (e.g., provide telemetry data without first receiving a request). In an example implementation, a system may comprise one or more devices that include at least one set of telemetry circuitry. The at least one set of telemetry circuitry may be configured to push data based at least on a frequency configuration and a skew configuration. The frequency configuration may control how often the at least one set of telemetry circuitry generates data. Generating data may include capturing data based on timing provided by a global clock in the system. The skew configuration may control when the telemetry data is transmitted. For example, sets of telemetry circuitry may be configured with different skew configurations to minimize transmission overlap. This may prevent telemetry data accumulation (TDA) circuitry in the system, which receives the transmission of telemetry data from the at least one set of telemetry circuitry, from becoming overwhelmed by multiple simultaneous transmission. The TDA circuitry may reside in, for example, processing circuitry in the system. The processing circuitry may use the telemetry data to control system operation.

In at least one embodiment, a system equipped for push telemetry data accumulation may comprise, for example, at least one set of telemetry circuitry and processing circuitry. The at least one set of telemetry circuitry may be to at least generate and transmit telemetry data. Moreover, the processing circuitry may be to execute code for transforming the processing circuitry into specialized circuitry to configure a frequency and skew in the at least one set of telemetry circuitry, the processing circuitry including at least TDA circuitry to receive the telemetry data from the at least one set of telemetry circuitry, wherein the at least one set of telemetry circuitry is to generate and transmit the telemetry data based on the frequency and skew configuration.

In at least one embodiment, the system may further comprise clock circuitry to maintain universal timing in the system, the clock circuitry including a plurality of timers. The processing circuitry may be to cause the plurality of timers to be synchronized. For example, the processing circuitry may cause the plurality of timers to be synchronized when the system is initialized.

The at least one set of telemetry circuitry may be to monitor the timing based on the frequency configuration. In generating the telemetry data, the at least one set of telemetry circuitry may be to capture the telemetry data when the timing is determined to correspond to the frequency configuration. In transmitting the telemetry data, the at least one set of telemetry circuitry may be to initiate a delay period based on the skew configuration when the timing is determined to correspond to the frequency configuration and then transmit the telemetry data to the telemetry data accumulation circuitry following the delay period. The processing circuitry may be to control the operation of the system based on the telemetry data. An example method for push telemetry data accumulation may comprise determining a timing from clock circuitry in a system and generating and transmitting telemetry data in at least one set of telemetry circuitry in the system based on a frequency configuration and skew configuration in the at least one set of telemetry circuitry.

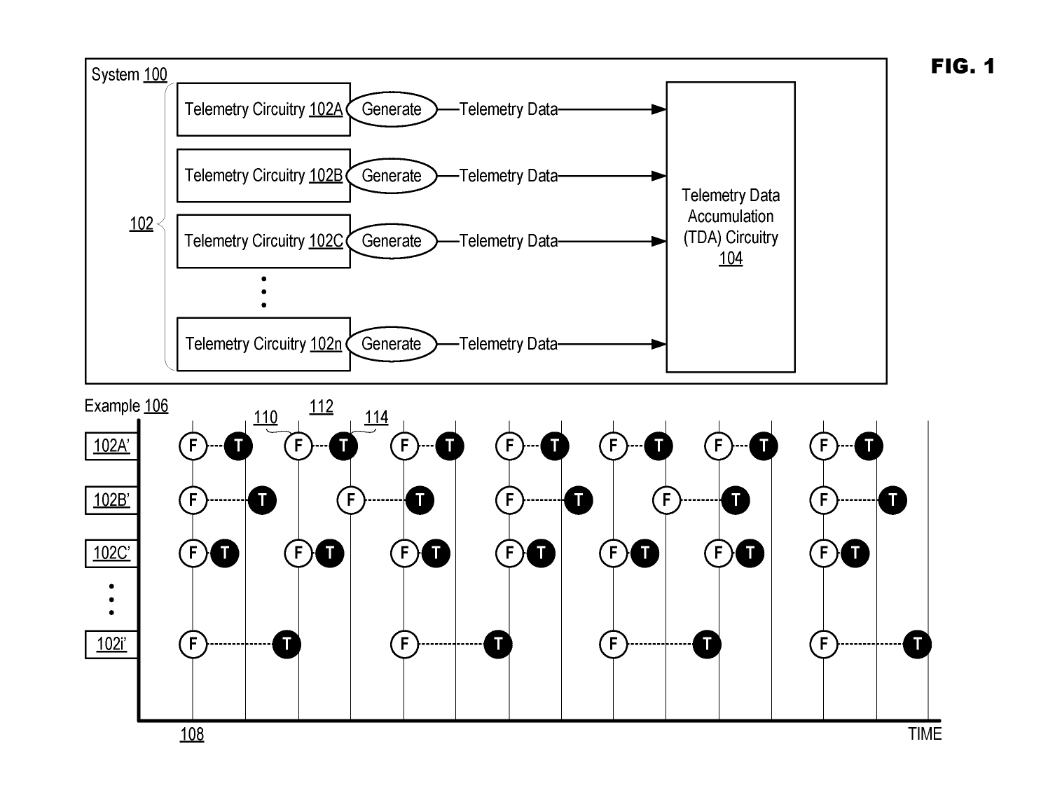

FIG. 1 illustrates examples of push telemetry data accumulation in accordance with at least one embodiment of the present disclosure. The following disclosure may make reference to, or may employ terminology commonly associated with, certain technologies associated with processors, other integrated circuits (ICs) and/or chipsets manufactured by the Intel Corporation, computer buses, memories, sensors, etc. These references are utilized herein merely for the sake of explanation, and are not intended to limit the various embodiments consistent with the present disclosure to any particular manner of implementation. While these example technologies may provide a basis for understanding the various embodiments, actual implementations may employ alternative technologies existing now or in the future. Moreover, the inclusion of an apostrophe after a drawing item number (e.g., 100′) in the present disclosure may indicate that an example embodiment of the particular item is being illustrated. These illustrated examples are also not intended to limit the various embodiments to any particular manner of implementation. As referenced herein, a “telemetry data” may comprise any data that may generated (e.g., captured, measured, etc.) by telemetry circuitry within a system. Telemetry circuitry may include sensors and other circuitry that may be employed to capture condition and/or performance-related data.

Consistent with the present disclosure, IPs may “push” telemetry information instead of requiring aggregators to “pull” the information (e.g., by sending a request to an IP from which telemetry data is desired). This type of operation may be, in general, more efficient in that the telemetry data is delivered without the TDA circuitry having to request the data. Moreover, the generation (e.g., capture time) of the telemetry data may be synchronized to global timing in the system. Many IPs may maintain high-precision timer accurate to nanosecond granularity. For example, PCIe IPs may maintain a precision time measurement (PTM) counter while non-PCIe IPs may maintain an always running timer (ART) that may be accessible via, for example, an input/output scale fabric (IOSF, e.g., a high speed interconnect between IPs). The availability of synchronized, high-precision timers may allow IPs to readily align to a timer, and thus the IPs may have the same linear view of time progression. In at least one embodiment, at least one of processor circuitry in the system, an aggregator, etc. may configure frequency and skew values for each IP. Frequency may configure the rate at which IP generates (e.g., captures, measures, snapshots, etc.) telemetry values in its internal buffers. Skew may be a fixed time-delta that may vary between IPs to distribute the instances at which the IPs transmit the captured telemetry data. For example, the actual instances at which an IP may transmit captured telemetry data (e.g., the time at which the telemetry data is “posted”), may be correspond to the most recent point in time corresponding to the frequency plus a delay defined by the skew. The posting of telemetry data (e.g., to the TDA circuitry) is typically done over, for example, an IOSF sideband or PCIe.

Referring to FIG. 1, system 100 may comprise at least one apparatus including resources configurable for data processing (e.g., for receiving data, processing data, outputting data, etc.). While for clarity the following disclosure will discuss an implementation of system 100 utilizing only one device, system 100 may also comprise a plurality of devices configured to operate in an individual or collaborative manner. Example devices that may make up system 100 include, but are not limited to, a mobile communication device such as a cellular handset or a smartphone based on the Android® OS from the Google Corporation, iOS® or Mac OS® from the Apple Corporation, Windows® OS from the Microsoft Corporation, Tizen® OS from the Linux Foundation, Firefox® OS from the Mozilla Project, Blackberry® OS from the Blackberry Corporation, Palm® OS from the Hewlett-Packard Corporation, Symbian® OS from the Symbian Foundation, etc., a mobile computing device such as a tablet computer like an iPad® from the Apple Corporation, Surface® from the Microsoft Corporation, Galaxy Tab® from the Samsung Corporation, Kindle® from the Amazon Corporation, etc., an Ultrabook® including a low-power chipset from the Intel Corporation, a netbook, a notebook, a laptop, a palmtop, etc., a wearable device such as a wristwatch form factor computing device like the Galaxy Gear® from Samsung, an eyewear form factor computing device/user interface like Google Glass® from the Google Corporation, a virtual reality (VR) headset device like the Gear VR® from the Samsung Corporation, the Oculus Rift® from the Oculus VR Corporation, etc., a typically stationary computing device such as a desktop computer, a server, a group of computing devices organized in a high performance computing (HPC) architecture, a smart television or other type of “smart” device, small form factor computing solutions (e.g., for space-limited applications, TV set-top boxes, etc.) like the Next Unit of Computing (NUC) platform from the Intel Corporation, etc.

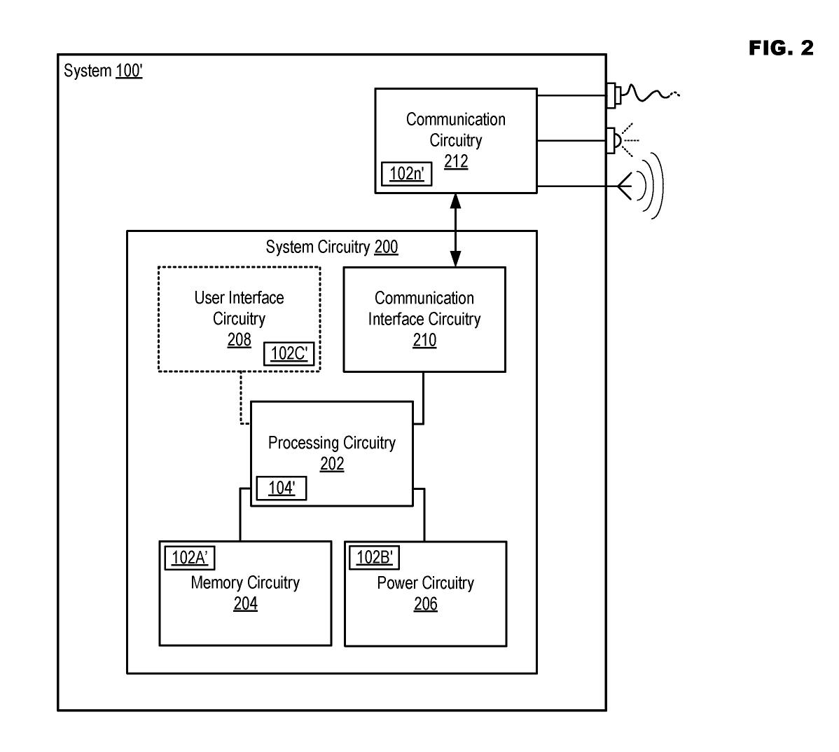

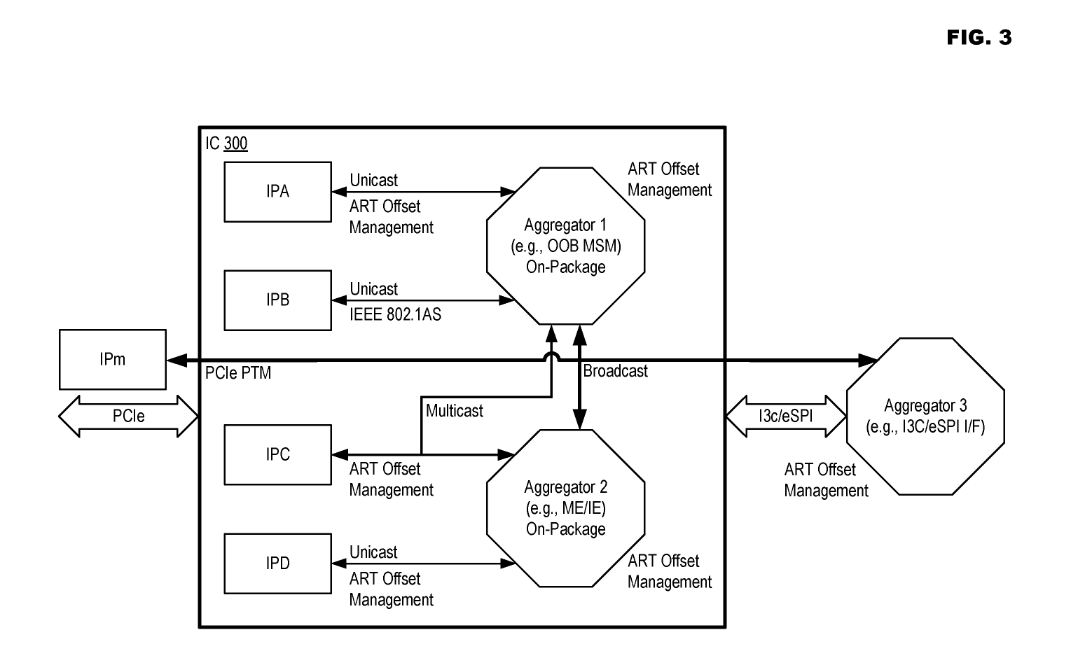

Example system 100 in FIG. 1 is an oversimplified illustration of an embodiment of the present disclosure intended to communicate basic system operation. More specific examples of device configuration, circuitry, etc. will be discussed in regard to FIGS. 2 and 3. System 100 may comprise at least one set of telemetry circuitry 102. For the sake of explanation, system 100 as illustrated in FIG. 1 comprises telemetry circuitry 102A, telemetry circuitry 102B, telemetry circuitry 102C . . . telemetry circuitry 102n (i.e., collectively “telemetry circuitry 102A . . . n”). Telemetry circuitry 102A . . . n may comprise IPs that are dedicated to providing telemetry data (e.g., temperature sensors, magnetic sensors, motion/acceleration/impact sensors to sense abrupt physical events such as a user dropping system 100, etc.) or IPs that are part of larger subsystems but that also report telemetry data (e.g., IPs that capture power consumption, processor loading, available memory, error rates, potential malware infiltration, etc.). Telemetry circuitry 102A . . . n may be integrated within system 100, installable in system 100 (e.g., as aftermarket equipment), etc. Regardless of the implementation of telemetry circuitry 102A . . . n, all of telemetry circuitry 102A . . . n may be configured to generate and then transmit telemetry data to TDA circuitry 104.

An example disclosing how the timing of telemetry data transmission may vary between telemetry circuitry 102A . . . n′ is illustrated in example 106 of FIG. 1. Example 106 shows a plot of how the transmission of telemetry data may be dispersed over time to avoid overwhelming TDA circuitry 104. Initially, telemetry circuitry 102A′, telemetry circuitry 102B′, telemetry circuitry 102C′ . . . telemetry circuitry 102n′ may each be configured with at least a frequency (F) 110 and a skew 112. For example, frequency 110 and skew 112 may be configured in each set of telemetry circuitry 102A . . . n′ whenever system 100 is initialized (e.g., powered up, rebooted, etc.). Frequency 110 may control when each set of telemetry circuitry 102A . . . n′ generates data. In at least one embodiment, universal timing in system 100 may be used to record the instant at which telemetry data is generated (e.g., captured, measured, etc.). Universal timing may allow any subsystem in system 100 to determine exactly when the telemetry data was generated. In example 106, repeating time periods 108 are shown to more clearly illustrate frequency 110. After each set of telemetry circuitry 102A . . . n′ generates telemetry data at frequency 110, skew 112 may cause each set of telemetry circuitry 102A . . . n′ to then delay for a period of time prior to transmitting (T) the telemetry data as illustrated at 114 in example 106. Consistent with the present disclosure, example 106 demonstrates that configuring frequency 110 and skew 112 may prevent telemetry circuitry 102A . . . n′ from transmitting telemetry data concurrently. This is evident in example 106 in that transmissions (T) 114 do not occur at the same time. As a result, TDA circuitry 104 is prevented from becoming overwhelmed by the simultaneous transmission of telemetry data by multiple sets of telemetry circuitry 102A . . . n′. This may allow for better performance in system 100 in that TDA circuitry 104 may continually receive telemetry data, synchronized to universal timing in system 100, in a non-overlapping manner without having the burden of controlling (e.g., requesting) telemetry data transmission.

FIG. 2 illustrates an example configuration for a system usable in accordance with at least one embodiment of the present disclosure. System 100′ may comprise one or more devices configured to operate individually or collaboratively, and may be capable of performing any or all of the activities disclosed in FIG. 1. However, system 100′ is presented only as an example of an apparatus usable in embodiments consistent with the present disclosure, and is not intended to limit any of the embodiments disclosed herein to any particular manner of implementation.

In the illustrated example configuration, system 100′ may comprise system circuitry 200 to manage general system operations. System circuitry 200 may include processing circuitry 202, memory circuitry 204, power circuitry 206, user interface circuitry 208 and communication interface circuitry 210. System 100′ may further include communication circuitry 212. While communication circuitry 212 is illustrated as separate from system circuitry 200, this example configuration is shown merely for the sake of explanation. Some or all of the functionality associated with communication circuitry 212 may also be incorporated into system circuitry 200.

In system 100′, processing circuitry 202 may comprise one or more processors situated in separate components, or alternatively one or more processing cores in a single component (e.g., in a system-on-chip (SoC) configuration), along with processor-related support circuitry (e.g., bridging interfaces, etc.). Example processors may include, but are not limited to, various x86-based microprocessors from the Intel Corporation including those in the Pentium®, Xeon®, Itanium®, Celeron®, Intel Atom®, Quark®, Core i-series and Core M-series product families, Advanced RISC (e.g., Reduced Instruction Set Computing) Machine or “ARM” processors, etc. Examples of support circuitry may include various chipsets (e.g., Northbridge, Southbridge, PCH, etc. from the Intel Corporation) to provide an interface through which processing circuitry 202 may interact with other system components that may be operating at different speeds, on different buses, etc. in system 100′. Moreover, some or all of the functionality associated with the support circuitry may be included in the same physical package as the processor (e.g., such as in the Sandy Bridge, Broadwell and Skylake families of processors from the Intel Corporation).

Processing circuitry 202 may be configured to execute various instructions in system 100′. Instructions may include program code configured to cause processing circuitry 202 to perform activities related to reading data, writing data, processing data, formulating data, converting data, transforming data, etc. Information (e.g., instructions, data, etc.) may be stored in memory circuitry 204. Memory circuitry 204 may comprise random access memory (RAM) and/or read-only memory (ROM) in a fixed or removable format. RAM may include volatile memory configured to hold information during the operation of system 100′ such as, for example, static RAM (SRAM) or dynamic RAM (DRAM). ROM may include non-volatile (NV) memory circuitry configured based on BIOS, UEFI, etc. to provide instructions when system 100′ is activated, programmable memories such as electronic programmable ROMs (EPROMS), Flash, etc. Other fixed/removable memory may include, but are not limited to, example magnetic memories such as hard disk (HD) drives, etc., example electronic memories such as solid state flash memory (e.g., embedded multimedia card (eMMC), etc.), removable memory cards or sticks (e.g., micro storage device (uSD), USB, etc.), example optical memories such as compact disc-based ROM (CD-ROM), Digital Video Disks (DVD), Blu-Ray Disks, etc.

Power circuitry 206 may include internal power sources (e.g., a battery, fuel cell, etc.) and/or external power sources (e.g., electromechanical or solar generator, power grid, external fuel cell, etc.), and related circuitry configured to supply system 100′ with the power needed to operate. User interface circuitry 208 may include hardware and/or software to allow users to interact with system 100′ such as, for example, various input mechanisms (e.g., microphones, switches, buttons, knobs, keyboards, speakers, touch-sensitive surfaces, one or more sensors configured to capture images and/or sense proximity, distance, motion, gestures, orientation, biometric data, etc.) and various output mechanisms (e.g., speakers, displays, lighted/flashing indicators, electromechanical components for vibration, motion, etc.). The hardware in user interface circuitry 208 may be incorporated within system 100′ and/or may be coupled to system 100′ via a wired or wireless communication medium. User interface circuitry 208 may be optional in certain circumstances such as, for example, a situation wherein system 100′ is a very small form factor device configured remotely (e.g., wirelessly) by another device, a server (e.g., rack server, blade server, etc.) that does not include user interface circuitry 208, and instead relies on another device (e.g., a management terminal) for user interface functionality, etc.

Communication interface circuitry 210 may be configured to manage packet routing and other control functions for communication circuitry 212 that may include resources configured to support wired and/or wireless communications. In some instances, system 100′ may comprise more than one set of communication circuitry 212 (e.g., including separate physical interface circuitry for wired protocols and/or wireless radios) managed by communication interface circuitry 210. Wired communications may include serial and parallel wired mediums such as, for example, Ethernet, USB, Firewire, Thunderbolt, Digital Video Interface (DVI), High-Definition Multimedia Interface (HDMI), etc. Wireless communications may include, for example, close-proximity wireless mediums (e.g., radio frequency (RF) such as based on the RF Identification (RFID) or Near Field Communications (NFC) standards, infrared (IR), etc.), short-range wireless mediums (e.g., Bluetooth®, WLAN, Wi-Fi, etc.), long range wireless mediums (e.g., cellular wide-area radio communication technology, satellite-based communications, etc.), electronic communications via sound waves, long-range optical communications, etc. In one embodiment, communication interface circuitry 210 may be configured to prevent wireless communications that are active in communication circuitry 212 from interfering with each other. In performing this function, communication interface circuitry 210 may schedule activities for communication circuitry 212 based on, for example, the relative priority of messages awaiting transmission. While the embodiment disclosed in FIG. 2 illustrates communication interface circuitry 210 being separate from communication circuitry 212, it may also be possible for the functionality of communication interface circuitry 210 and communication circuitry 212 to be incorporated into the same circuitry.

Consistent with the present disclosure, telemetry circuitry 102A . . . n′ and/or TDA circuitry 104′ may include hardware, software or combinations thereof. In an example hardware implementation, telemetry circuitry 102A . . . n′ and/or TDA circuitry 104′ may include dedicated circuitry (e.g., an IC, chipset, multi-chip module (MCM), etc. with or without firmware), or may be part of other circuitry (e.g., processing circuitry 202). In an example software and hardware implementation, at least a portion of telemetry circuitry 102A . . . n′ and/or TDA circuitry 104′ may reside in processing circuitry 202 and/or memory circuitry 204. For example, telemetry circuitry 102A . . . n′ and/or TDA circuitry 104′ may comprise code executed by processing circuitry 202, wherein at least a portion of the code may be stored in memory circuitry 204. Processing circuitry 202 may execute the code to transform processing circuitry 202 from general purpose data processing circuitry into specialized circuitry to perform at least the functions associated with telemetry circuitry 102A . . . n′ and/or TDA circuitry 104′. In an example of operation, telemetry circuitry 102A . . . n′ may transmit telemetry data to TDA circuitry 104′ in processing circuitry 202, which may accumulate the telemetry data. Processing circuitry 202 may then evaluate the telemetry data for use in managing operations in system 100.

FIG. 3 illustrates an example configuration for a telemetry system in accordance with at least one embodiment of the present disclosure. IC 300 may be for example, part of processing circuitry 202 in the form of uncore functionality, PCH support circuitry, etc. IC 300 may exist in system 100 and may comprise various IPs including, for example, IPA, IPB, IPC, IPD . . . IPm (i.e., collectively “IPA . . . m”) and aggregators 1 and 2. For example, IPA may communicate using a unicast communication protocol (e.g., one sender transmitting to one receiver) wherein global time alignment may be maintained via an always running timer (ART) offset management (e.g., IOSF global time synch for IPs not on a PCIe bus). IPB may communicate using a unicast communication protocol and maintain global time alignment via the IEEE 802.1AS timing and synchronization standard (e.g., such as set forth in the latest version of the standard: draft 7.6 dated Nov. 11, 2010). IPC may communicate using a multicast communication protocol (e.g., one sender transmitting to a set of receivers) and maintain global time alignment via ART offset management. IPD may communicate using a unicast communication protocol and maintain global time alignment via ART offset management. IPm may exist outside of IC 300 (e.g., in another IC, chipset, MCM, etc.). IPm may communicate via a broadcast communication protocol (e.g., one sender transmitting indiscriminately to all receivers) and maintain global timing via the PCIe bus. Aggregator 1 may be, for example, an on-package (e.g., within IC 300) OOB MSM configured to accumulate telemetry data from IPA . . . m. Aggregator 2 may be, for example, an on-package ME/IE also configured to accumulate telemetry data from IPA . . . m. Aggregator 3 may be situated outside of IC 300 and may be configured to accumulate telemetry data via a next-generation Inter-Integrated Circuit (I3C) bus or enhanced serial parallel interface (eSPI) bus while maintaining global time alignment utilizing ART offset management.

In an example of operation, IPA . . . n and aggregators 1, 2 and 3 may align to a global time counter (e.g., system reference clock) when system 100 is initialized. As part of the silicon (e.g., IC) reset sequence, IPA . . . n and aggregators 1, 2 and 3 may initialize their timers utilizing ART management or PCIe precision time measurement (PTM) methods. All internal IPs may now be aligned to an ART via IOSF sideband distribution protocol. External IPs may be synched up via the PCIe PTM protocol. All Aggregators may also implement similar protocols to align to global timing. Aggregator 1, 2 and/or 3 may then program each IPA . . . m with at least a frequency value 110 to control when each of the IPs generate telemetry data and a skew value 112 to control when each IPA . . . m transmits the telemetry data to aggregators 1, 2 or 3 (e.g., to reduce IOSF sideband conflicts and internal buffering requirements for aggregators 1, 2 and 3 since telemetry data delivery is more distributed over time). In addition, by defining an IOSF “multicast” address, IPA . . . m may post/deliver telemetry values to multiple aggregators 1, 2 and/or 3 at the same time. In addition, IPA . . . m may deliver telemetry data to an external aggregator 3 via an IOSF sideband end-point represented by eSPI/I3C I/F. In at least one embodiment, since telemetry data is delivered via unicast, multicast or broadcast communication, aggregators 1, 2 and/or 3 may subscribe or unsubscribe to different IPA . . . m to control communication traffic. Subscribing/unsubscribing may occur, for example, during the initial programming of IPA . . . m.

The above example enables aggregators 1, 2 and/or 3 to receive time-accurate snapshots of telemetry data but have them delivered based on the pre-programmed skew. In at least one embodiment, if multiple aggregators 1, 2 and/or 3 program the same frequency/skew value to at least one IPA . . . m, then the IPA . . . m comprising the conflicting configuration may automatically convert to a multicast/broadcast response to transmit telemetry data to all interested aggregators 1, 2 or 3. There are numerous optimizations that can be driven once time-alignment is achieved. Global time based on ART/PTM/802.1AS-1588 has nanosecond granularity, however many of the SW/FW agents may be expected to only require data at milli/micro second interval accuracy.

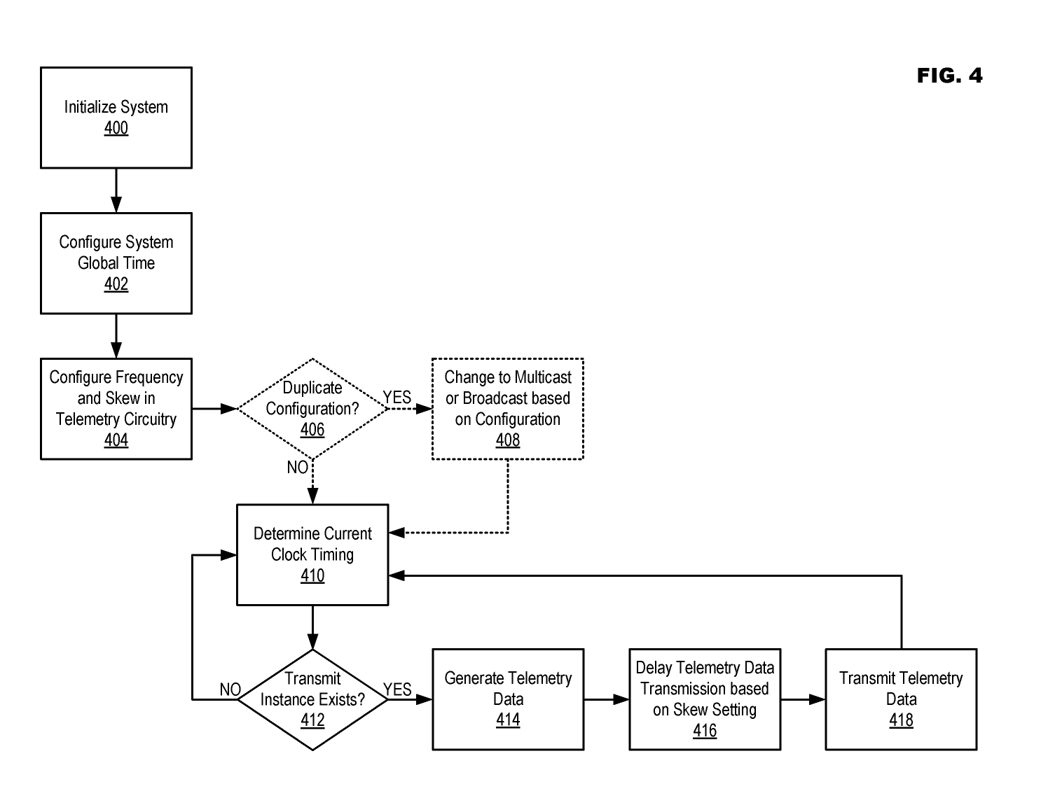

FIG. 4 illustrates example operations for push telemetry data accumulation in accordance with at least one embodiment of the present disclosure. A system may be initialized in operation 400. For example, the system may be powered up, rebooted, etc. In operation 402 global time may be configured in the system. For example, a variety of timers may be synchronized to a system reference clock. At least frequency and skew values may then be configured in each set of telemetry circuitry in the system in operation 404. For example, processing circuitry and/or TDA circuitry in the system may configure each set of telemetry circuitry. Operations 406 to 408 may be optional in that their implementation may depend on a variety of criteria including, for example, the architecture, capabilities, etc. of the system (e.g., or of the devices making up the system), an intended use of the system, operational environment, etc. A determination may be made in operation 406 as to whether at least one set of telemetry circuitry has been configured with duplicate frequency and skew values (e.g., by different sets of TDA circuitry). If in operation 406 it is determined that duplicate values have been configured, then in operation 408 the communication protocol for the telemetry circuitry may be changed from unicast to multicast or broadcast to more efficiently service the consumers (e.g., multiple sets of TDA circuitry).

Following a “no” determination in operation 406 or operation 408, in operation 410 the current clock timing may be determined. The clock timing may be determined in operation 410 until a determination is made in operation 412 that a transmit instance has occurred. A transmit instance may be determined based on, for example, the current clock timing corresponding to a time that telemetry data should be generated and transmitted based on the frequency value. If it is determined in operation 412 that a transmit instance exists, then in operation 414 telemetry data may be generated (e.g., captured, measured, etc.). The telemetry circuitry may then delay in operation 416 based on the skew value prior to transmitting the telemetry data in operation 418. The transmission of the telemetry data in operation 418 may be followed by a return to operation 410 to continue monitoring the clock timing (e.g., in preparation for the next transmit instance).

While FIG. 4 illustrates operations according to an embodiment, it is to be understood that not all of the operations depicted in FIG. 4 are necessary for other embodiments. Indeed, it is fully contemplated herein that in other embodiments of the present disclosure, the operations depicted in FIG. 4, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to push telemetry data accumulation. A system may comprise at least telemetry circuitry configured to push telemetry data (e.g., provide telemetry data without first receiving a request). An example system may comprise one or more devices that include at least one set of telemetry circuitry. The at least one set of telemetry circuitry may be configured to push data based at least on a frequency configuration and a skew configuration. The frequency configuration may control how often the at least one set of telemetry circuitry generates data. The skew configuration may control when the telemetry data is transmitted. For example, sets of telemetry circuitry may be configured with different skew configurations to minimize transmission overlap. This may prevent telemetry data accumulation (TDA) circuitry in the system, which receives the transmission of telemetry data from the at least one set of telemetry circuitry, from becoming overwhelmed.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for push telemetry data accumulation.

According to example 1 there is provided a system equipped for push telemetry data accumulation. The system may comprise at least one set of telemetry circuitry to at least generate and transmit telemetry data and processing circuitry to execute code for transforming the processing circuitry into specialized circuitry to configure a frequency and skew in the at least one set of telemetry circuitry, the processing circuitry including at least telemetry data accumulation circuitry to receive the telemetry data from the at least one set of telemetry circuitry, wherein the at least one set of telemetry circuitry is to generate and transmit the telemetry data based on the frequency and skew configuration.

Example 2 may include the elements of example 1, further comprising clock circuitry to maintain universal timing in the system, the clock circuitry including a plurality of timers.

Example 3 may include the elements of example 2, wherein the processing circuitry is to cause the plurality of timers to be synchronized.

Example 4 may include the elements of example 3, wherein the processing circuitry causes the plurality of timers to be synchronized when the system is initialized.

Example 5 may include the elements of any of examples 3 to 4, wherein the plurality of timers includes at least one always running timer.

Example 6 may include the elements of example 5, wherein the at least one always running timer is synchronized via offset management.

Example 7 may include the elements of any of examples 2 to 6, wherein the at least one set of telemetry circuitry is monitor the timing based on the frequency configuration.

Example 8 may include the elements of example 7, wherein in generating the telemetry data the at least one set of telemetry circuitry is to capture the telemetry data when the timing is determined to correspond to the frequency configuration.

Example 9 may include the elements of example 8, wherein in transmitting the telemetry data the at least one set of telemetry circuitry is to initiate a delay period based on the skew configuration when the timing is determined to correspond to the frequency configuration and then transmit the telemetry data to the telemetry data accumulation circuitry following the delay period.

Example 10 may include the elements of any of examples 1 to 9, wherein the processing circuitry is further to control the operation of the system based on the telemetry data.

According to example 11 there is provided a method for push telemetry data accumulation. The method may comprise determining a timing from clock circuitry in a system; and generating and transmitting telemetry data in at least one set of telemetry circuitry in the system based on a frequency configuration and skew configuration in the at least one set of telemetry circuitry.

Example 12 may include the elements of example 11, and may further comprise initializing the system and synchronizing the clock circuitry.

Example 13 may include the elements of any of examples 11 to 12, and may further comprise setting the frequency configuration and the skew configuration in the at least one set of telemetry circuitry.

Example 14 may include the elements of any of examples 11 to 13, wherein generating the telemetry data comprises capturing the telemetry data when the timing is determined to correspond to the frequency configuration.

Example 15 may include the elements of any of examples 11 to 14, wherein transmitting the telemetry data comprises initiating a delay period based on the skew configuration when the timing is determined to correspond to the frequency configuration and transmitting the telemetry data following the delay period.

Example 16 may include the elements of any of examples 11 to 15, and may further comprise receiving the telemetry data at telemetry data accumulation circuitry in processing circuitry in the system.

According to example 17 there is provided a system for push telemetry data accumulation including at least one device, the system being arranged to perform the method of any of the above examples 11 to 16.

According to example 18 there is provided a chipset arranged to perform the method of any of the above examples 11 to 16.

According to example 19 there is provided at least one machine readable medium comprising a plurality of instructions that, in response to be being executed on a computing device, cause the computing device to carry out the method according to any of the above examples 11 to 16.

According to example 20 there is provided at least one device configured for push telemetry data accumulation, the at least one device being arranged to perform the method of any of the above examples 11 to 16.

According to example 21 there is provided a system for push telemetry data accumulation. The system may comprise means for determining a timing from clock circuitry in a system and means for generating and transmitting telemetry data in at least one set of telemetry circuitry in the system based on a frequency configuration and skew configuration in the at least one set of telemetry circuitry.

Example 22 may include the elements of example 21, and may further comprise means for initializing the system and means for synchronizing the clock circuitry.

Example 23 may include the elements of any of examples 21 to 22, and may further comprise means for setting the frequency configuration and the skew configuration in the at least one set of telemetry circuitry.

Example 24 may include the elements of any of examples 21 to 23, wherein the means for generating the telemetry data comprise means for capturing the telemetry data when the timing is determined to correspond to the frequency configuration.

Example 25 may include the elements of any of examples 21 to 24, wherein the means for transmitting the telemetry data comprise means for initiating a delay period based on the skew configuration when the timing is determined to correspond to the frequency configuration and means for transmitting the telemetry data following the delay period.

Example 26 may include the elements of any of examples 21 to 25, and may further comprise means for receiving the telemetry data at telemetry data accumulation circuitry in processing circuitry in the system.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1. A system equipped for push telemetry data accumulation, comprising:
clock circuitry to maintain global time alignment utilizing always running timer (ART) offset management or to synchronize global timing utilizing a global synchronization standard;
at least one set of telemetry circuitry to at least generate and transmit telemetry data; and
processing circuitry to execute code for transforming the processing circuitry into specialized circuitry to configure a frequency and skew in the at least one set of telemetry circuitry, the processing circuitry including at least telemetry data accumulation circuitry to:
determine if a plurality of sets of telemetry data accumulation circuitry exist in the system;
when a plurality of sets of telemetry data accumulation circuitry are determined to exist, configure a unicast, multicast or broadcast communication protocol for the at least one set of telemetry circuitry based on the frequency and skew configurations; and
receive the telemetry data from the at least one set of telemetry circuitry, wherein the at least one set of telemetry circuitry is to generate and transmit the telemetry data based on the frequency and skew configuration.

2. The system of claim 1, further comprising clock circuitry to maintain universal timing in the system, the clock circuitry including a plurality of timers.

3. The system of claim 2, wherein the processing circuitry is to cause the plurality of timers to be synchronized.

4. The system of claim 3, wherein the processing circuitry causes the plurality of timers to be synchronized when the system is initialized.

5. The system of claim 2, wherein the at least one set of telemetry circuitry is monitor the timing based on the frequency configuration.

6. The system of claim 5, wherein in generating the telemetry data the at least one set of telemetry circuitry is to capture the telemetry data when the timing is determined to correspond to the frequency configuration.

7. The system of claim 6, wherein in transmitting the telemetry data the at least one set of telemetry circuitry is to initiate a delay period based on the skew configuration when the timing is determined to correspond to the frequency configuration and then transmit the telemetry data to the telemetry data accumulation circuitry following the delay period.

8. The system of claim 1, wherein the processing circuitry is further to control the operation of the system based on the telemetry data.

9. A method for push telemetry data accumulation, comprising:
maintaining global time alignment utilizing always running timer (ART) offset management or to synchronize global timing utilizing a global synchronization standard utilizing clock circuitry;
configuring a frequency and skew in at least one set of telemetry circuitry;
determining if a plurality of sets of telemetry data accumulation circuitry exist in the system;
when a plurality of sets of telemetry data accumulation circuitry are determined to exist, configuring a unicast, multicast or broadcast communication protocol for the at least one set of telemetry circuitry based on the frequency and skew configurations;
determining a timing from clock circuitry in a system; and
generating and transmitting telemetry data in the at least one set of telemetry circuitry in the system based on the frequency configuration and skew configuration in the at least one set of telemetry circuitry.

10. The method of claim 9, further comprising:
initializing the system; and
synchronizing the clock circuitry.

11. The method of claim 9, further comprising:
setting the frequency configuration and the skew configuration in the at least one set of telemetry circuitry.

12. The method of claim 9, wherein generating the telemetry data comprises capturing the telemetry data when the timing is determined to correspond to the frequency configuration.

13. The method of claim 9, wherein transmitting the telemetry data comprises:
initiating a delay period based on the skew configuration when the timing is determined to correspond to the frequency configuration; and
transmitting the telemetry data following the delay period.

14. The method of claim 9, further comprising:
receiving the telemetry data at telemetry data accumulation circuitry in processing circuitry in the system.

15. At least one non-transitory machine-readable storage medium having stored thereon, individually or in combination, instructions for push telemetry data accumulation that, when executed by one or more processors, cause the one or more processors to:
maintain global time alignment utilizing always running timer (ART) offset management or to synchronize global timing utilizing a global synchronization standard utilizing clock circuitry;
configure a frequency and skew in at least one set of telemetry circuitry;
determine if a plurality of sets of telemetry data accumulation circuitry exist in the system;
when a plurality of sets of telemetry data accumulation circuitry are determined to exist, configure a unicast, multicast or broadcast communication protocol for the at least one set of telemetry circuitry based on the frequency and skew configurations;
determine a timing from clock circuitry in a system; and
generate and transmit telemetry data in the at least one set of telemetry circuitry in the system based on the frequency configuration and skew configuration in the at least one set of telemetry circuitry.

16. The storage medium of claim 15, further comprising instructions that, when executed by one or more processors, cause the one or more processors to:
initialize the system; and
synchronize the clock circuitry.

17. The storage medium of claim 15, further comprising instructions that, when executed by one or more processors, cause the one or more processors to:
set the frequency configuration and the skew configuration in the at least one set of telemetry circuitry.

18. The storage medium of claim 15, wherein the instructions to generate the telemetry data comprises instructions to capture the telemetry data when the timing is determined to correspond to the frequency configuration.

19. The storage medium of claim 15, wherein the instructions to transmit the telemetry data comprise instructions to:
initiate a delay period based on the skew configuration when the timing is determined to correspond to the frequency configuration; and
transmit the telemetry data following the delay period.

20. The storage medium of claim 15, further comprising instructions that, when executed by one or more processors, cause the one or more processors to:
receive the telemetry data at telemetry data accumulation circuitry in processing circuitry in the system.
